(19) United States
(12) Patent Application Publication
(10) Pub. No.: US 2003/0223560 A1
(43) Pub. Date: Dec. 4, 2003

(54) Caller ID printing device

(75) Inventors: David W. Stauffer, Portland, OR (US); Joseph P. Hoffbeck, Portland, OR (US)

Correspondence Address: Kolisch Hartwell, P.C., 200 Pacific Building, 520 S.W. Yamhill Street, Portland, OR, 97204, US

(73) Assignee: Stauf Ent., Inc.

(21) Appl. No.: 10/359,882

(22) Filed: Feb. 6, 2003

Related U.S. Application Data
(60) Provisional application No. 60/384,141, filed on May 29, 2002.

(51) Int. Cl. H04M 1/56; H04M 15/06

(52) U.S. Cl. 379/142.14; 379/142.01; 379/142.04; 379/142.17

(57) ABSTRACT

A caller ID printing device is provided. The printing device typically includes a controller configured to detect caller ID information from an incoming call and a printer configured to automatically print the caller ID information and a message template onto a printed call record.

This application is based upon and claims the benefit under 35 U.S.C. § 119 of U.S. Provisional Patent Application Serial No. 60/384,141, filed May 29, 2002, which is incorporated herein by reference.

### TECHNICAL FIELD

The present invention relates generally to telephone systems, and more particularly to a system and method for printing caller ID information associated with a telephone call.

### BACKGROUND OF THE INVENTION

Practically since the invention of the telephone, people have been taking messages for persons unable to take telephone calls. Both in business and residential settings, people often transcribe voice mail, or simply jot down a message from a live caller. However, taking such messages is time-consuming and subject to error. Often, a caller's name is misspelled or number is written erroneously, the time of the call is forgotton, etc. It would be desirable to provide a reliable, time-saving system and method for taking telephone messages.

### SUMMARY OF THE INVENTION

A caller ID printing device is provided. The printing device typically includes a controller configured to detect caller ID information from an incoming call and a printer configured to automatically print the caller ID information and a message template onto a printed call record.

The advantages of the present invention will be understood more readily after a consideration of the drawings and the Detailed Description.

### BRIEF DESCRIPTION OF THE DRAWINGS

FIG. 1 is a schematic view of a caller ID printing system according to one embodiment of the present invention.

FIG. 2 is a detail view of a call record of the system of FIG. 1.

FIG. 3 is a perspective view of the caller ID printing device of FIG. 1.

### DETAILED DESCRIPTION

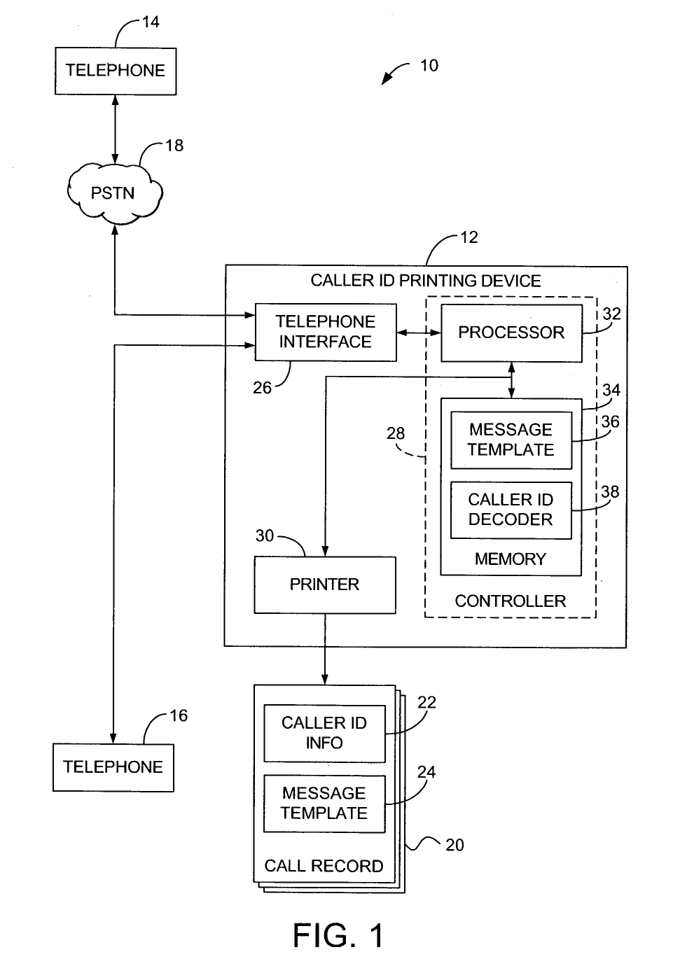

Referring initially to FIG. 1, a caller ID printing system according to one embodiment of the present invention is shown generally at 10. System 10 typically includes a caller ID printing device 12 configured to receive a call sent from a calling party telephone 14 to a called party telephone 16 via a public switched telephone network (PSTN) 18. For each call received, caller ID printing device 12 is configured to print a call record 20 including caller ID information 22 detected from the call, and a message template 24, as described below. It should be appreciated that the printing device does not require the presence of a telephone 16 in order to function, and that telephone 16 may alternatively be connected in parallel to the caller ID printing device 12. Additionally, or in the alternative, the caller ID printing device may be in serial or parallel connection with a caller ID display unit, a telephone answering machine, or other device.

Caller ID printing device 12 typically includes a telephone interface 26 configured to receive calls from PSTN 18. Caller ID information is typically sent over the phone line between the first and second ring signals of an incoming call. Telephone interface 26 is configured to monitor the telephone line, and after a ring signal and valid caller ID signal are received from PSTN 18, that information is forwarded to a controller 28. Controller 28 typically includes a processor 32 configured to access memory 34. A caller ID decoder program 38 and a message template 36 typically are stored in memory 34. Typically, processor 32 is configured to execute the caller ID decoder 38 and read the caller ID information passed to it from telephone interface 26. Processor 32 further is configured to cause printer 30 to print call record 20 containing caller ID information 22 read from each call in a human-readable form, as well as message template 24 that the user may use to record additional information about the call.

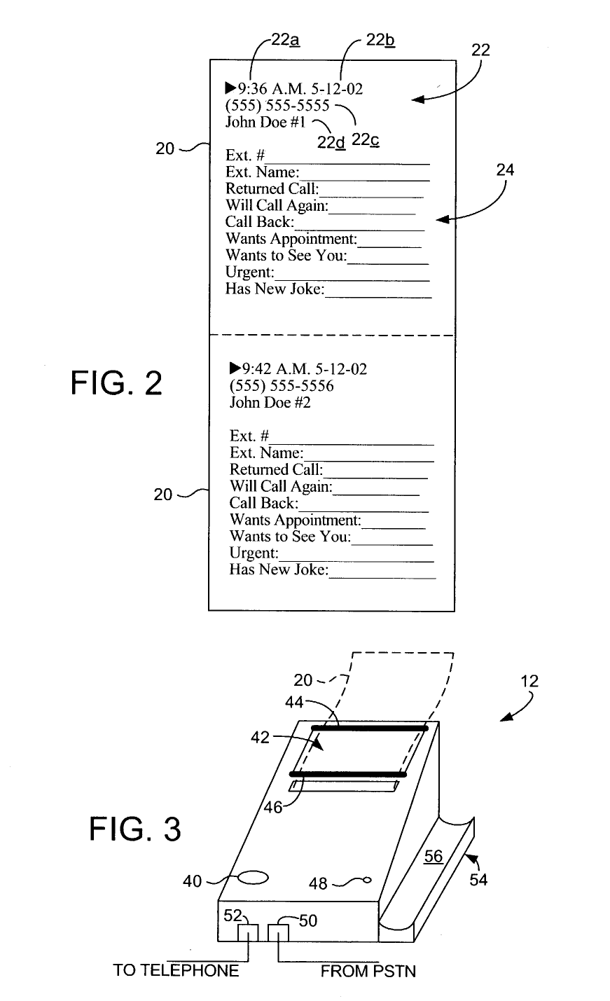

As shown in FIG. 2, caller ID information 22 typically includes a time 22a and date 22b at which the call was received. Caller ID information 22 may further include a calling party telephone number 22c and/or a calling party name 22d. In one aspect of the invention, the printing device may be capable of printing a caller's date, time of day, area code, phone number, and the caller ID name associated with the caller's phone number.

The caller ID printing device may be configured to print the caller ID information at the same time as the message template. Alternatively, the caller ID printing device may be configured to print the caller ID information prior to, or after the printing of the message template. For example, the caller ID printing device may be configured to print the caller ID information automatically as soon as it has been decoded. For example, the caller ID printing device may print the caller ID information between receipt of the first and second ring signals. In some embodiments, the printed caller ID information may be used to screen an incoming call in order to decide whether to answer the call or not.

Message template 24 typically includes items such as message-related indicia. These message related indicia may include “extension number,” “extension name,” “returned call,” “will call again,” “call back,” “wants appointment,” “wants to see you,” “urgent,” and “has new joke.” It should be appreciated that a variety of other indicia may be provided that are generally applicable, or that may be customized for a particular individual, particular occupation, or a place of business. The indicia may be preprinted on the call record, or the printing device may print such indicia as needed.

Each message-related indicia typically is followed by a line or blank space in which the message taker may record relevant information. Typically, the message taker will form-feed the call record, by pressing form-feed button 40, shown in FIG. 3, and position the message template 24 within a writing area 42 and hand-write the information within the blank spaces provided in message template 24. Typically, writing area 42 includes a flat writing surface bounded at an upper end by an upper serrated bar 44 and at a lower end by lower serrated bar 46. The user may separate individual call records 20 formed on a single roll of paper by tearing the call records at an appropriate location using bar 44. Alternatively, the paper may not be threaded under bar 44 and may, instead, be torn using only the lower bar 46. In addition, a power indicator 48 may be provided to let the user know that the power is turned on to the device. Caller ID printing device 12 additionally may include ports 50 and 52 configured to receive connections from PSTN 18 and called party telephone 16.

Caller ID printing device 12 further may include a receptacle 54 positioned adjacent a surface of the device, including a well 56 adapted to hold a writing implement, such as a pen or pencil.

In one aspect of the invention, the printer paper used by the printing device may be 2¼″ (56 mm.) thermal paper on a roll that sits on a spindle and feeds through the machine so that each caller ID message can be neatly torn from the paper roll. Although the printing device may use thermal offset printing, any other printing method that creates a legible record of the caller ID information is a useful printing method for the purposes of the present disclosure.

The printing device may include a power source such as one or more batteries, or an external power supply, such as a connection to a conventional 120V AC wall outlet. The printing device may include a back-up power supply unit to maintain a supply of electricity during times when power is interrupted, but such a back-up power supply unit is not necessary for operation of the printing device.

The present invention has the advantage that a message taker need not write the called time, date, telephone number, and calling party name for each message taken. Rather, the message taker may take advantage of the call records 20 printed by caller ID printing device 12 and easily and quickly record relevant message-specific information within message template 24 and distribute the call record to the intended message recipient. In one aspect of the invention, the printing device may be configured to automatically print a note every time the device receives caller ID information. If the user desires additional space on the printed call record to write notes, the user may trigger form-feed button 40 to advance the paper. Thus, the present device is thought to save time and resources over prior message-taking methods. The only action required of the user is the initial setup which includes plugging the printing device into the power outlet and a phone jack, and loading paper into the print device. Caller ID information may be printed immediately and automatically after the first ring of each incoming call without any user intervention.

The printing device may also be used as a note-taking device, in the absence of an incoming call. That is, where the printing device is kept, for example, at a bedside, it is convenient for the user to advance the roll of paper over writing surface 42 in order to write a message or notes on the paper. The paper may then be further advanced and torn off for future reference or distribution.

The printing device may be small and compact, to facilitate placement wherever the printing device would be convenient. For example, the printing device may be appropriately sized to rest upon a night table.

Manufacture of the printing device may include configuring a telephone interface to receive an incoming call, configuring a controller to detect caller ID information from the incoming call, configuring the controller to send the caller ID information to a printer, and configuring the printer to automatically print the caller ID information received from the controller onto a printed call record. Manufacture may also include associating the controller with both the telephone interface and the printer, for example by interconnecting the controller, the interface and the printer with the appropriate wiring, and placing the associated components within an attractive case. Such manufacture may also include configuring a mechanism to advance the printer paper supply, such as the form-feed button discussed above.

While the present invention has been particularly shown and described with reference to the foregoing preferred embodiments, those skilled in the art will understand that many variations may be made therein without departing from the spirit and scope of the invention. The present invention is intended to embrace all such alternatives, modifications and variances that fall within the scope of the appended claims. The description of the invention should be understood to include all novel and non-obvious combinations of elements described herein, and claims may be presented in a later related application to any novel and non-obvious combination of these elements. Where the disclosure recites “a” or “a first” element or the equivalent thereof, such disclosure should be understood to include incorporation of one or more such elements, neither requiring nor excluding two or more such elements.

What is claimed is:

1. A caller ID printing device, comprising:
a controller configured to detect caller ID information from an incoming call;
and a printer configured to automatically print the caller ID information and a message template onto a printed call record.

2. The caller ID printing device of claim 1, further comprising an actuator, configured to position the printed message template within a writing area when activated so that additional information can be manually entered on the message template.

3. The caller ID printing device of claim 2, where the actuator is a form-feed button.

4. The caller ID printing device of claim 1, where the message template includes one or more message-related indicia.

5. The caller ID printing device of claim 4, where the message-related indicia includes one or both of checkboxes and blanks.

6. The caller ID printing device of claim 1, further comprising a memory where the controller includes a processor configured to access the memory.

7. The caller ID printing device of claim 6, where the memory includes a caller ID decoder program.

8. The caller ID printing device of claim 6, where the memory includes the message template.

9. The caller ID printing device of claim 1, where the caller ID information includes one or more of an incoming call time, an incoming call date, a calling party telephone number, and a calling party name.

10. The caller ID printing device of claim 1, where the printer is configured to print the caller ID information before the incoming call is answered.

11. The caller ID printing device of claim 1, where the printer is configured to print the caller ID information after the first ring of each incoming call.

12. A method of automatically printing caller ID information for an incoming call, comprising:
a) providing a printing device, where the printing device includes
a controller configured to detect caller ID information from an incoming call; and
a printer configured to automatically print the caller ID information onto a printed call record;
b) receiving an incoming call at the printing device, where the incoming call includes caller ID information;
c) detecting the caller ID information; and
d) printing automatically a call record that includes the caller ID information and a message template.

13. The method of claim 12, further comprising:
advancing the printed message template to a writing area; and
manually entering additional information on the message template.

14. The method of claim 12, where printing the caller ID information includes printing one or more of an incoming call time, an incoming call date, a calling party telephone number, and a calling party name.

15. A note printing device, comprising:
a paper supply;
a writing surface;
a paper advance mechanism, configured to advance the paper supply to a writing surface; and
a writing implement receptacle.

16. The note printing device of claim 15, where the paper supply includes a roll of paper.

17. The note printing device of claim 16, further comprising a printer, and a processor that is configured to automatically print caller ID information from an incoming telephone call on the paper supply using the printer.
